(19) United States
(12) Patent Application Publication
(10) Pub. No.: US 2015/0298272 A1
(43) Pub. Date: Oct. 22, 2015

(54) MACHINE TOOL

(71) Applicant: Okuma Corporation, Niwa-Gun (JP)

(72) Inventor: Atsuya MURATA, Niwa-Gun (JP)

(21) Appl. No.: 14/643,104

(22) Filed: Mar. 10, 2015

(30) Foreign Application Priority Data
Apr. 17, 2014 (JP) 2014-085769

(51) Int. Cl. B23Q 7/02

(52) U.S. Cl. CPC B23Q 7/02

(57) ABSTRACT

A machine tool includes a pallet exchanger that is placed adjacent to one side of a body cover covering a workpiece machining space, and that exchanges a first pallet on which a machined workpiece is mounted and that is fixed to an upper surface of a table and a second pallet on which a workpiece to be machined is mounted. The pallet exchanger includes a turning member that has a first holding portion and a second holding portion formed in a pair and turns in a horizontal direction. The first holding portion is located at a first end of the turning member and holds the first pallet, and the second holding portion is located at a second end on the opposite side of the turning member from the first end and holds the second pallet.

### BACKGROUND OF THE INVENTION

This application claims the benefit of Japanese Patent Application Number 2014-085769 filed on Apr. 17, 2014, the entirety of which is incorporated by reference.

1. Field of the Invention

The present invention relates to machine tools in which a machining space of the machine tool is covered by a body cover, and a pallet exchanger is placed adjacent to one side of the body cover and exchanges a first pallet on which a machined workpiece is mounted and a second pallet on which a workpiece to be machined is mounted. The first pallet is fixed to an upper surface of a table placed in the machining space.

2. Description of Related Art

For example, in a machine tool disclosed in Japanese Patent No. 4342474, a workpiece machining space is provided in a body of the machine tool and covered by a first cover, a table is placed in the machining space and a workpiece is fixed on an upper surface of the table. In the machine tool, a pallet exchanger is provided inside a second cover that is continuous with the right side of the first cover and exchanges a pallet that is fixed to the upper surface of the table and on which a machined workpiece is mounted and a pallet on which a workpiece to be machined is mounted. The pallet exchanger includes a pallet moving base that has a plurality of pallet bases on its upper surface and that rotates and moves in the horizontal direction, and a transfer mechanism that is placed between the pallet moving base and the body of the machine tool and that transfers a pallet moved to a predetermined position and placed on the pallet base by the pallet moving base between the pallet base and the table of the machine tool.

In this machine tool, a transfer member provided in the transfer mechanism can advance and withdraw to and from the table through a pallet exchange hole formed in the right side of the first cover. The pallet that is fixed to the upper surface of the table and on which the machined workpiece is mounted and the pallet on which the workpiece to be machined is mounted are exchanged by carrying the pallet in and out through the pallet exchange hole.

In this machine tool, however, the pallet exchanger includes the transfer mechanism in addition to the pallet moving base. Accordingly, the pallet moving base and the transfer mechanism need to be synchronized in order to allow the pallet to be transferred to the table of the machine tool by the transfer mechanism immediately after the pallet is moved to the predetermined position by the pallet moving base. This may complicate the structure of the pallet exchanger as a control unit that synchronizes the pallet moving base with the transfer mechanism, etc.

Moreover, the pallet exchanger requires time to pass the pallet between the pallet moving base and the transfer mechanism when transferring the pallet between the pallet moving base and the table. In this case, as the time required to pass the pallet is accumulated, the time required to exchange the pallet on which the machined workpiece is mounted and the pallet on which the workpiece to be machined is mounted can be increased.

### SUMMARY OF THE INVENTION

It is an object of the present invention to provide a machine tool capable of simplifying the structure of a pallet exchanger and reducing the time required to exchange pallets by the pallet exchanger.

A first aspect of the present invention is a machine tool that is capable of machining a workpiece with a tool by relatively moving the tool and a table in a workpiece machining space provided in a body of the machine tool. The machine tool includes pallets on which the workpiece is mounted, a body cover that covers the machining space and that is provided with a first door. The first door faces the machining space and opens and closes an opening provided on a front surface of the body cover. The machine tool further includes a pallet exchanger that is placed adjacent to one side of the body cover and that exchanges the pallets including a first pallet and a second pallet. The first pallet is fixed to an upper surface of the table and a machined workpiece is mounted on the first pallet, and a workpiece to be machined is mounted on the second pallet. In the machine tool, the pallet exchanger includes a turning member that has a first holding portion and a second holding portion formed in a pair and turns in a horizontal direction. The first holding portion is located at a first end of the turning member and holds the first pallet, and the second holding portion is located at a second end that is on the opposite side of the turning member from the first end and holds the second pallet. At least one of the turning member and the table can be advanced and withdrawn through a workpiece loading and unloading port provided in the body cover. The turning member can be advanced and withdrawn into and from the machining space through the workpiece loading and unloading port. The first pallet held by the first holding portion is carried from the upper surface of the table to the pallet exchanger and the second pallet held by the second holding portion is carried from the pallet exchanger to the upper surface of the table in the machining space, by advancing the turning member into the machining space through the workpiece loading and unloading port and then turning the turning member in the horizontal direction in the machining space. The table can be advanced and withdrawn toward or from the pallet exchanger through the workpiece loading and unloading port. The first pallet held by the first holding portion is carried from the upper surface of the table to the pallet exchanger and the second pallet held by the second holding portion is carried from the pallet exchanger to the upper surface of the table in the machining space, by advancing the table toward the pallet exchanger through the workpiece loading and unloading port and then turning the turning member in the horizontal direction on the pallet exchanger side.

According to a second aspect of the present invention, in the first aspect, the first holding portion or the second holding portion can be indexed to such a position that the first holding portion or the second holding portion faces toward a front of the pallet exchanger by turning the turning member in the horizontal direction on the pallet exchanger side.

According to a third aspect of the present invention, in the first aspect, a side cover that covers the pallet exchanger is provided on one side of the body cover, and the side cover is provided with a second door that faces the turning member and that opens and closes an opening provided on a front surface of the side cover.

According to a fourth aspect of the present invention, in any one of the first to third aspects, the table can swing about a swing shaft that extends perpendicularly to an approaching and separating direction of the turning member to and from the body cover.

According to a fifth aspect of the present invention, in the fourth aspect, support portions that swingably support the swing shaft are placed in front of and behind the table, respectively, and the support portion placed in front of the table is made smaller than that placed behind the table.

According to a sixth aspect of the present invention, in the fifth aspect, a first rail member having an arc shape about an axis of the swing shaft is fixed to a front surface of the table at a position below the upper surface of the table, The support portion placed in front of the table is provided with an engagement member that engages with the first rail member. The table swings about the swing shaft as the swing shaft swings and the first rail member swings about the swing shaft accordingly while being engaged with the engagement member.

According to a seventh aspect of the present invention, in the sixth aspect, a second rail member is located at a position below the upper surface of the table before swinging, and the engagement member is fixed to the second rail member. The second rail member having an arc shape about the axis of the swing shaft is supported by the support portion placed in front of the table so that the second rail member can swing about the swing shaft. The first rail member is provided with an engagement portion that is engaged by the engagement member, and that swings the second rail member about the swing shaft as the first rail member swings about the swing shaft.

In the machine tool according to the first aspect of the present invention, the turning member of the pallet exchanger can carry the first pallet on which the machined workpiece is mounted and the second pallet on which the workpiece to be machined is mounted, between the table and the pallet exchanger in the machining space by turning in the horizontal direction. Moreover, the turning member can carry the first pallet and the second pallet between the table and the pallet exchanger by moving in the approaching and separating direction to and from the body cover. Since the turning member can perform a plurality of operations, namely the turning operation and the operation of moving in the approaching and separating direction to and from the body cover, it is not necessary to separately provide a device for turning the turning member and a device for moving the turning member in the approaching and separating direction to and from the body cover and to provide a device for synchronizing these devices. This can simplify the structure of the pallet exchanger.

Moreover, since the turning member can perform the plurality of operations (the turning operation and the operation of moving in the approaching and separating direction to and from the body cover), it is not necessary to separately provide the device for turning the turning member and the device for moving the turning member in the approaching and separating direction to and from the body cover. Therefore, the time (passing time) required to pass the pallets between these devices can be eliminated. Accordingly; when exchanging the first pallet and the second pallet between the table and the pallet exchanger, the passing time is not accumulated, whereby the time required to exchange the first and second pallets can be reduced.

If the table advances toward the pallet exchanger through the workpiece loading and unloading port, the turning member turns in the horizontal direction on the pallet exchanger side without moving in the approaching and separating direction to and from the body cover. Accordingly, the first pallet on which the machined workpiece is mounted and the second pallet on which the workpiece to be machined is mounted can be carried between the table and the pallet exchanger.

According to the second aspect of the present invention, the user of the machine tool can carry the first pallet, on which the machined workpiece is mounted and which is held by the first holding portion of the turning member, out of the pallet exchanger from the front of the pallet exchanger. The user also can carry the second pallet on which the workpiece to be machined is mounted toward the second holding portion of the turning member from the front of the pallet exchanger. This makes it easier for the operator of the machine tool to carry a workpiece into and out of the pallet exchanger.

According to the third aspect of the present invention, the user of the machine tool can open the opening provided on the front surface of the side cover by the second door. Therefore, the pallet on which the machined workpiece is mounted can be carried out of the side cover from the first holding portion of the turning member through the opened opening provided on the front surface, and the pallet on which the workpiece to be machined is mounted can be carried to the second holding portion of the turning member from the outside of the side cover through the opened opening provided on the front surface. Since the front surface of the body of the machine tool can be located close to the position in the side cover to and from which the workpiece is to be carried, it is easier for the operator of the machine tool to carry a workpiece in and out of the side cover.

According to the fourth aspect of the present invention, the swing shaft for the table is not provided at a position in the approaching and separating direction of the turning member to and from the body cover. The swing shaft therefore does not interfere with the approach of the turning member to the table.

According to the fifth aspect of the present invention, for example, the workpiece on the table is less likely to hide behind the support portion placed in front of the table, and thus the user of the machine tool is less likely to have difficulty in checking or inspecting the workpiece on the table through the front surface of the body cover which has been opened by the first door. This makes it easier for the user of the machine tool to check or inspect the workpiece on the table.

According to the sixth aspect of the present invention, before the table starts swinging about the swing shaft or when the table swings about the swing shaft, the first rail member does not protrude beyond the upper surface of the table from the front surface of the table. The workpiece fixed to the upper surface of the table therefore does not hide behind the first rail member, and the user of the machine tool can easily check or inspect the workpiece.

According to the seventh aspect of the present invention, the table to which the first rail member is fixed can swing by a swingable angle defined by the swinging range of the second rail member in addition to a swingable angle defined by the swinging range of the first rail member. The swingable angle of the table can thus be increased as compared to the case where the table is swung according to swinging of the first rail member.

### BRIEF DESCRIPTION OF THE DRAWINGS

FIG. 1 is an overall perspective view of a vertical machining center according to a first embodiment of the present invention.

FIG. 2 is a schematic perspective view of the vertical machining center of the first embodiment, in which a body cover and a side cover are not shown.

FIG. 3 is a diagram showing the state where a pallet on which a machined workpiece is mounted is placed on a table of the vertical machining center, and a pallet on which a workpiece to be machined is mounted is held by one pair of holding arms included in a turning member of a pallet exchanger.

FIG. 4 is a diagram showing the state where a pallet on which a machined workpiece is mounted is placed on the table, and the other pair of holding arms of the turning member is indexed to the table side.

FIG. 5 is a diagram showing the state where a pallet placed on the table (a pallet on which a machined workpiece is mounted) is held by the other pair of holding arms.

FIG. 6 is a diagram showing the state where a pallet on which a machined workpiece is mounted and being held by the other pair of holding arms is indexed to the pallet exchanger side, and a pallet on which a workpiece to be machined is mounted and being held by the one pair of holding arms is indexed to the table side.

FIG. 7 is a diagram showing the state where a pallet on which a machined workpiece is mounted and being held by the other pair of holding arms is horizontally moved toward the palled changer.

FIG. 8 is a diagram showing the state where a pallet on which a machined workpiece is mounted and being held by the other pair of holding arms is indexed so as to directly face the front of a side cover that covers the pallet exchanger.

FIG. 9 is a schematic perspective view of a vertical machining center according to a second embodiment, in which a body cover and a side cover are not shown.

FIG. 10 is a schematic front view of the vertical machining center.

FIG. 11 is a schematic side view of the vertical machining center.

FIG. 12 is an exploded perspective view of a table and a support portion that swingably supports the front part of the table in the vertical machining center.

FIG. 13 is a schematic front view of the vertical machining center with the table being swung.

FIG. 14 is a schematic perspective view of the vertical machining center with the table being swung.

### DETAILED DESCRIPTION OF THE EMBODIMENTS

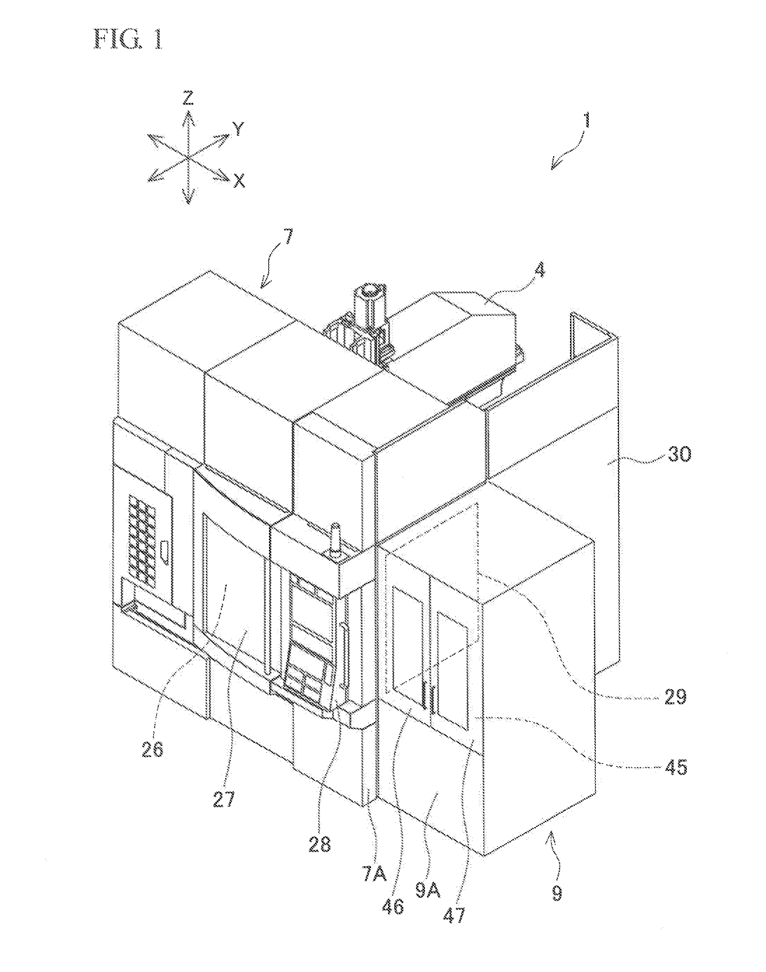

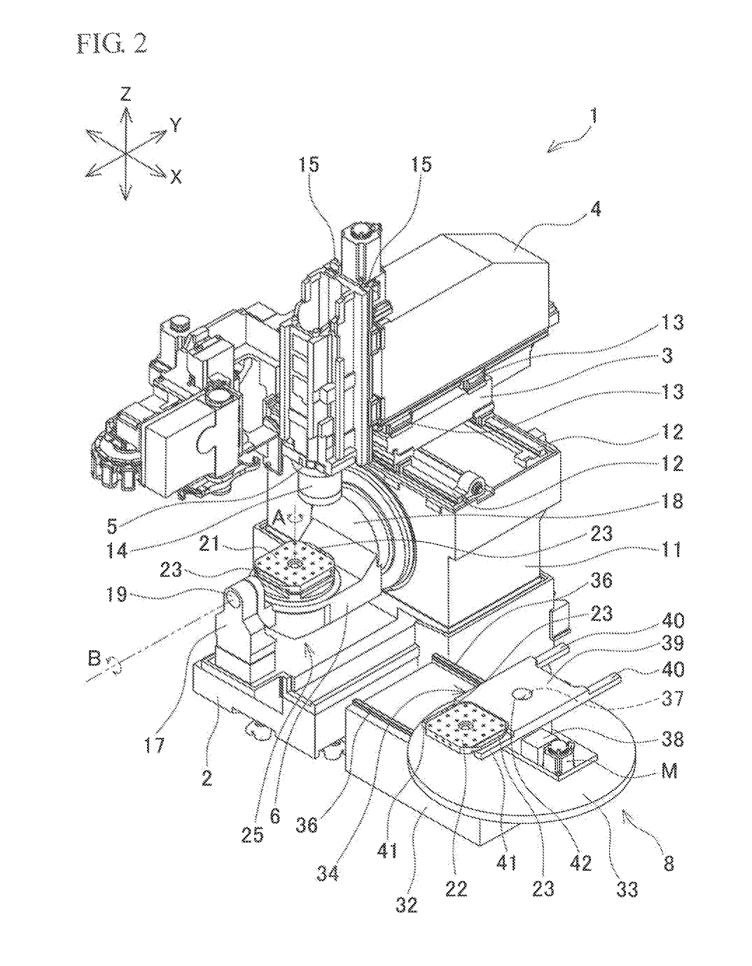

A first embodiment of the present invention will be described with reference to FIGS. 1 to 8. A vertical machining center 1 shown in FIGS. 1 and 2 includes a bed 2, a saddle 3, a column 4, a spindle head 5, a table 6, a body cover 7, a pallet exchanger 8, and a side cover 9. The vertical machining center 1 is an example of the machine tool in the present invention.

As shown in FIG. 2, the bed 2 has a rectangular shape that is longer in the longitudinal direction (Y-axis direction) as viewed in plan, and is placed on the floor. A standing portion 11 is provided on the upper surface of the rear end part of the bed 2 so as to stand upward. The saddle 3 is provided over the upper surface of the standing portion 11 such that the saddle 3 can be guided by X-axis guide rails 12, 12 to move in the lateral direction (X-axis direction). The column 4 is provided over the upper surface of the saddle 3 such that the column 4 can be guided by a Y-axis guide member 13 to move in the Y-axis direction. The spindle head 5 rotatably supporting a spindle 14 is provided over the front surface of the column 4 such that the spindle head 5 can be guided by Z-axis guide rails 15, 15 to move in the vertical direction (Z-axis direction) parallel to the axis of the spindle 14.

As shown in FIG. 2, the table 6 is placed above the upper surface of the front part of the bed 2 and below the spindle 14 in the Z-axis direction. Moreover, the table 6 is supported at its both ends by the standing portion 11 placed behind the table 6 in the Y-axis direction and a support portion 17 provided on the front end part of the upper surface of the bed 2 so as to stand in front of the table 6 in the Y-axis direction, The standing portion 11 is provided with a swing drive device 18 that swings the table 6 about a B-axis parallel to the Y-axis direction, and the rear part of the table 6 is connected to the swing drive device 18. The front part of the table 6 is supported by the support portion 17 via a rotatable swing shaft 19. As shown in FIG. 2, the vertical dimension of the support portion 17 is smaller than that of the swing drive device 18. In the present embodiment, the table 6 can be swung about the B-axis and the swing shaft 19 by driving the swing drive device 118. The support portion 117 is an example of the support portion placed in front of the table in the present invention, and the swing drive device 18 is an example of the support portion placed behind the table in the present invention.

The table 6 has a fixing mechanism (not shown) that fixes a pallet (a first pallet) 21 (see FIG. 2), on which a workpiece (not shown) is mounted to the upper surface of the table 6. The table 6 further has an indexing drive device (not shown) that rotates the first pallet 21 fixed to the upper surface of the table 6 about an A-axis to index the first pallet 21 to a predetermined position. The A-axis is a rotation axis of the table 6.

The body cover 7 shown in FIG. 1 is made of sheet steel, and is formed substantially in the shape of a box that opens on its lower surface (on the lower side in FIG. 1) and its rear surface. This body cover 7 covers the front, upper, and right and left sides of the bed 2 except the standing portion 11 shown in FIG. 2. In the present embodiment, the table 6 is provided inside the body cover 7 and is placed in a space above the upper surface of the front part of the bed 2. This space is a machining space 25 (see FIG. 2) for the workpiece. The bed 2 is an example of the body of the machine tool in the present invention.

The front surface of the body cover 7 has an opening 26 near its center in the lateral direction of the front surface. The opening 26 faces the machining space 25 (see FIG. 2). An open and close door 27 that opens and closes the opening 26 is provided on the front surface of the body cover 7 so as to be movable horizontally in the lateral direction of the front surface. The opening 26 is opened by moving the open and close door 27 horizontally to the left. The user of the vertical machining center I can check and inspect the workpiece placed on the upper surface of the table 6 or inspect the vertical machining center 1, etc. via the opening 26. An operation unit 28 is used to operate the vertical machining center 1 and to enter parameters etc. of a workpiece machining program. The operation unit 28 is provided on the right side of the opening 26 on the front surface of the body cover 7. The open and close door 2.7 is an example of the first door in the present invention.

A right side surface 7A of the body cover 7 has a workpiece loading and unloading port 29 (see FIG. 1) that allows the inside of the body cover 7 to communicate with the outside. The workpiece loading and unloading port 29 is used to carry a pallet (a second pallet) 22 (see FIG. 2), on which a workpiece to be machined is mounted, onto the table 6 in the body cover 7 and to carry the first pallet 21 (see FIG. 2), on which a machined workpiece is mounted from the upper surface of the table 6 out of the body cover 7 by the pallet exchanger 8 described below. Moreover, a protective plate 30 made of a metal is fixed and attached to the rear edge of the right side surface 7A of the body cover 7 in order to protect the right side of the column 4. The protective plate 30 has the same height as the side surface 7A, and extends rearward of the body cover 7 beyond the rear end of the column 4.

Since the vertical machining center 1 of the present embodiment has the above configuration, the spindle head 5 can be moved relative to the workpiece mounted on the first pallet 21 on the table in the directions of X-, Y-, and Z-axes that are perpendicular to each other. The table 6 can be swung about the B-axis, and the first pallet 21 on the table 6 can be rotated about the A-axis and indexed to a (predetermined position. For example, the vertical machining center 1 can thus cut or turn the workpiece with a tool in the machining space 25 by mounting the tool on the spindle 14 and controlling the relative positions of the tool and the workpiece by 5-axis (X-axis, Y-axis, Z-axis, A-axis, and B-axis) control.

As shown in FIGS. 1 and 2, the pallet exchanger 8 is placed to adjoin the right side surface 7A of the body cover 7. The pallet exchanger 8 includes a fixed base 32, a moving base 33, and a turning member 34. The right side surface 7A of the body cover 7 is an example of the one side of the body cover in the present invention.

The fixed base 32 is placed on the floor so as to adjoin the right side of the bed 2. The moving base 33 has a substantially circular shape as viewed in plan, and can be driven by a motor M to move horizontally. A pair of guide rails 36, 36 are provided on the upper surface of the fixed base 32 so as to extend in an approaching and separating direction to and from the body cover 7 (in this example, the lateral direction). The moving base 33 can be guided by the pair of guide rails 36, 36 to move horizontally in the approaching and separating direction. A rotary shaft 37 is provided on the upper surface of the moving base 33 so as to protrude therefrom. The rotary shaft 37 is rotationally driven by a motor (not shown). Moreover, a lifting device 38 is placed on the upper surface of the moving base 33 so as to adjoin the rotary shaft 37. The lifting device 38 moves the turning member 34 up and down, and includes a rod (not shown) that extends and retracts in the vertical direction.

The turning member 34 includes a body 39, a first pair of holding arms 40, 40, and a second pair of holding arms 41, 41. The body 39 is made of a metal plate having a rectangular shape as viewed in plan. The first pair of holding arms 40, 40 protrude outward from one end (a first end) of the body 39 and face each other. The second pair of holding arms 41, 41 protrude outward from the other end (a second end) of the body 39 and face each other, As shown in FIG. 2, each of the first and second pallets 21, 22 having a quadrangular shape has engagement protrusions 23 along its two opposing sides. The engagement protrusions 23 extend outward, and each pallet 21, 22 can be held by the first holding arms 40, 40 or the second holding arms 41, 41 when the engagement protrusions 23 engage with the upper surfaces of the first holding arms 40, 40 or the upper surfaces of the second holding arms 41, 41. As shown in FIG. 2, the body 39 has a fitting hole 42 substantially in its center so that the rotary shaft 37 can be detachably fitted therein. The turning member 34 can be supported by the moving base 33 by fitting the rotary shaft 37 in the fitting hole 42. In this supported state, the turning member 34 is flush with the upper surface of the table 6 in such a state that the workpiece loading and unloading port 29 (see FIG. 1) of the body cover 7 is interposed the turning member 34 and the table 6. The turning member 34 can be turned in the horizontal direction by rotationally driving the rotary shaft 37 with the rotary shaft 37 being fitted in the fitting hole 42. As described later, the turning member 34 supported by the moving base 33 can be advanced and withdrawn into and from the machining space 25 through the workpiece loading and unloading port 29 by horizontally moving the moving base 33 in the approaching and separating direction to and from the body cover 7. Moreover, the turning member 34 can be supported by the rod of the lifting device 38 and moved up and down by fitting the rod in a recess (not shown) formed in the bottom surface of the turning member 34 and extending and retracting the rod. The first holding arms 40, 40 and the second holding arms 41, 41 are an example of a pair of the holding portions in the present invention.

Like the body cover 7, the side cover 9 shown in FIG. 1 is made of sheet steel, and is formed substantially in the shape of a box that opens on its lower surface and its left side surface. The side cover 9 is fixed to the right side surface 7A of the body cover 7 so as to be continuous with the body cover 7. The side cover 9 covers the pallet exchanger 8. The side cover 9 has an opening 45 substantially on the upper half of its front surface 9A such that the opening 45 faces the turning member 34 (see FIG. 2). Double doors 46, 47 that open and close the opening 45 are provided substantially on the upper half of the front surface 9A. The double doors 46, 47 can open and close the opening 45 via hinge portions (not shown) provided on the right and left edges of the opening 45. For example, the user of the vertical machining center 1 can carry the second pallet 22, on which a workpiece to be machined, toward the first holding arms 40, 40 or the second holding arms 41, 41 through the opening 45, and can carry the first pallet 21, on which a machined workpiece is mounted, from the first holding arms 40, 40 or the second holding arms 41, 41 out of the side cover 9. The double doors 46, 47 are an example of the second door in the present invention.

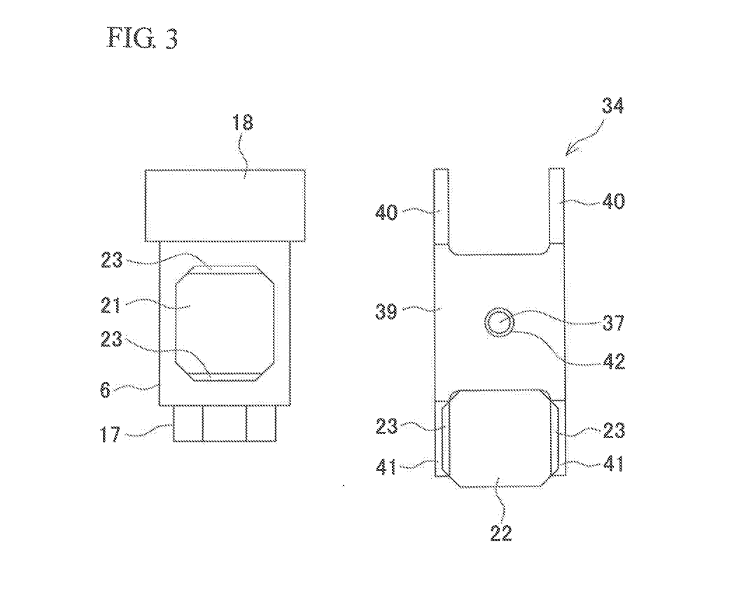

Operation of the vertical machining center 1 will be described below. An example will be described below in which the pallet exchanger 8 is operated in the state where the first pallet 21 (see FIG. 2), on which a machined workpiece is mounted, is placed on the upper surface of the table 6. The user of the vertical machining center 1 opens the double doors 46, 47 (see FIG. 1) to open the opening 45, and then carries the second pallet 22, on which a workpiece to be machined is mounted, into the side cover 9 through the opening 45 so that the second pallet 22 is held by the second holding arms 41, 41 of the turning member 34 as shown in FIGS. 2 and 3. In the present embodiment, the double doors 46, 47 are provided on the front surface 9A of the side cover 9 that is continuous with the body cover 7. Accordingly, the front surface of the body cover 7 on which the operation unit 28 (see FIG. 1) is provided can be located close to the opening 45 through which the operator carries the workpiece into the side cover 9. This makes it easier for the user of the vertical machining center 1 to carry the workpiece into the side cover 9 and operate the operation unit 28, for example.

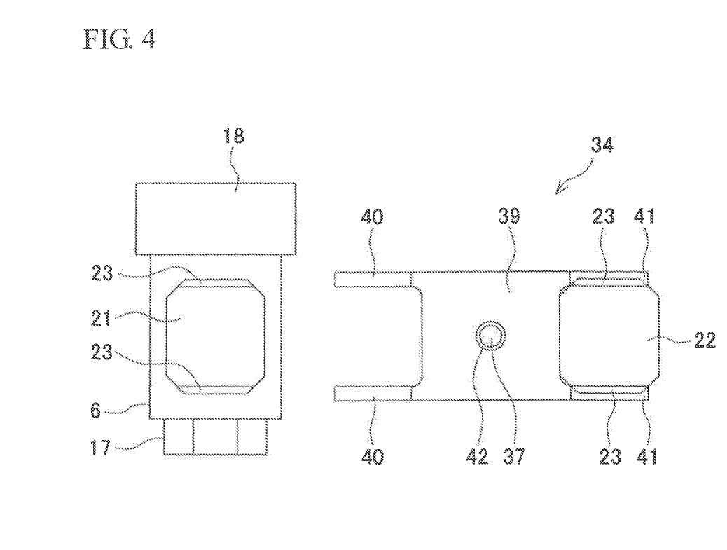

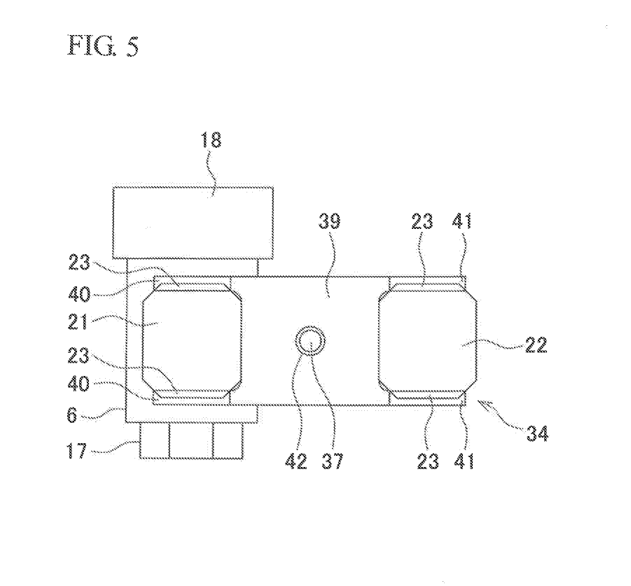

After the second pallet 22 is held by the second holding arms 41, 41, the rotary shaft 37 is rotationally driven in the side cover 9 to rotate the turning member 34 counterclockwise. As shown in FIG. 4, the first holding arms 40, 40 are thus indexed so as to be flush with and adjacent to the first pallet 21 on the table 6 in the lateral direction of the vertical machining center 1 in such a state that the workpiece loading and unloading port 29 (see FIG. 1) is interposed between first holding arms 40, 40 and the first pallet 21. Subsequently, the motor M shown in FIG. 2 is driven to guide the moving base 33 by the guide rails 36, 36, so that the moving base 33 is moved horizontally in the approaching direction to the body cover 7. The first holding arms 40, 40 of the turning member 34 supported by the moving base 33 thus advances into the machining space 25 (see FIG. 2) through the workpiece loading and unloading port 29, and then holds the first pallet 21 as shown in FIG. 5. In the present embodiment, the swing shaft 19 of the table 6 is placed on the front side with respect to the approaching direction in the machining space 25 so as to extend perpendicularly to the approaching direction. Since the swing shaft 19 is not provided at a position in the approaching direction, the swing shaft 19 does not interfere with the approach of the turning member 34 to the table 6.

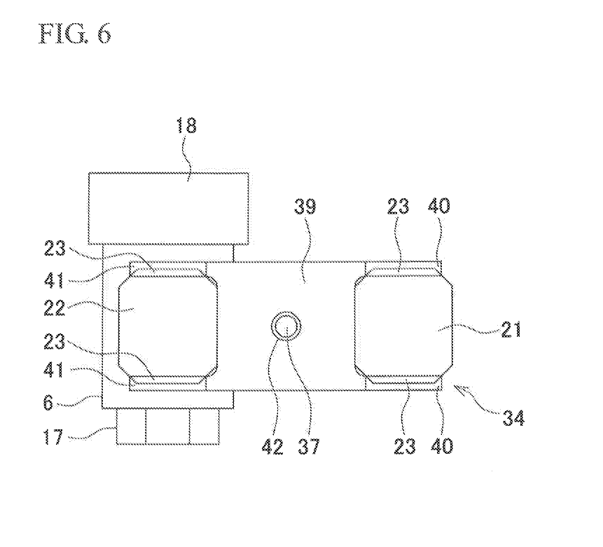

After the first holding arms 40, 40 hold the first pallet 21 as shown in FIG. 5, the rod of the lifting device 38 shown in FIG. 2 is extended to fit in the recess of the turning member 34. In this state, the rod is further extended by a predetermined length to lift the turning member 34 with the rotary shaft 37 being fitted in the fitting hole 42, and the first holding arms 40, 40 (the first pallet 21) are fixed at a predetermined distance above the upper surface of the table 6. Then, the rotary shaft 37 is rotationally driven to rotate the turning member 34 clockwise in the machining space 25, so that the second holding arms 41, 41 (the second pallet 22) are indexed to a position above the upper surface of the table 6 instead of the first holding arms 40, 40, as shown in FIG. 6. At the same time, the first holding arms 40, 40 (the first pallet 21) are indexed from the upper surface of the table 6 to a position on the pallet exchanger 8 side. Thereafter, the rod of the lifting device 38 is retracted to lower the turning member 34, so that the second pallet 22 is placed on the upper surface of the table 6 and the rod of the lifting device 38 is removed from the recess of the turning member 34. The second pallet 22, on which the workpiece to be machined is mounted, is thus carried from the pallet exchanger 8 onto the upper surface of the table 6. The pallet 22 is an example of the second pallet in the present invention.

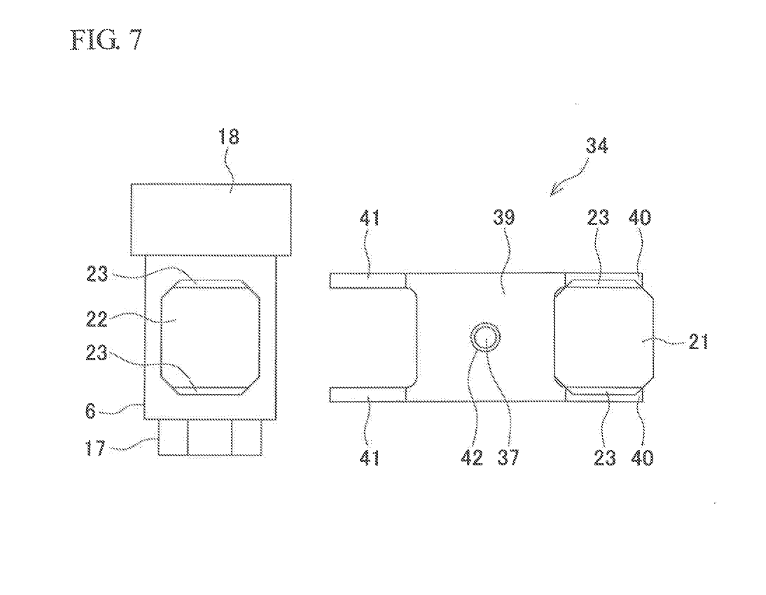

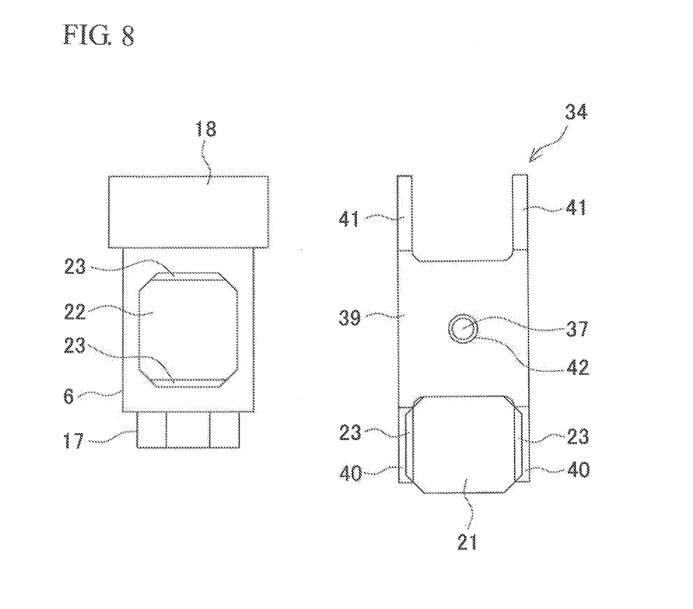

Subsequently, the motor M shown in FIG. 2 is driven to guide the moving base 33 by the guide rails 36, 36, so that the moving base 33 is moved horizontally in the separating direction from the body cover 7. The first holding arms 40, 40 of the turning member 34 supported by the moving base 33, which are shown in FIG. 7, are moved out of the machining space 25 through the workpiece loading and unloading port 29. Then, the first holding arms 40, 40 are moved in the separating direction to such a position inside the side cover 9 that the first holding arms 40, 40 face the opening 45 (see FIG. 1). Thereafter, the rotary shaft 37 is rotationally driven inside the side cover 9 to rotate the turning member 34 clockwise, so that the first holding arms 40, 40 (the first pallet 21) are indexed to directly face the opening 45, as shown in FIG. 8. The first pallet 21 on which the machined workpiece is mounted is thus carried from the upper surface of the table 6 to the pallet exchanger 8. The user of the vertical machining center 1 carries the first pallet 21, on which the machined workpiece is mounted, out of the side cover 9 from the first holding arms 40, 40 through the opening 45. The pallet 21 is an example of the first pallet in the present invention.

In the present embodiment, the vertical dimension of the support portion 17 is smaller than that of the swing drive device 18 shown in FIG. 2. This can make it less likely for the workpiece on the table 6 to hide behind the support portion 17 and thus can make it less likely for the user of the vertical machining center 1 to have difficulty in checking or inspecting the workpiece on the table 6 through the opening 26 (see FIG. 1) after opening it by horizontally moving the open and close door 27 (see FIG. 1), for example.

In the vertical machining center 1 of the present invention, the turning member 34 of the pallet exchanger 8 can carry the first pallet 21 on which a machined workpiece is mounted and the second pallet 22 on which a workpiece to be machined is mounted between the table 6 and the pallet exchanger 8 by turning in the horizontal direction in the machining space 25. Moreover, the turning member 34 can carry the first pallet 21 and the second pallet 22 between the table 6 and the pallet exchanger 8 by moving horizontally in the approaching and separating direction to and from the body cover 7. Since the turning member 34 can perform a plurality of operations, namely, the turning operation and the operation of moving horizontally in the approaching and separating direction to and from the body cover 7, it is not necessary to separately provide a device for turning the turning member 34 and a device for moving the turning member 34 horizontally in the approaching and separating direction to and from the body cover 7 and to provide a device for synchronizing these devices. This can simplify the structure of the pallet exchanger 8.

Moreover, since the turning member 34 can perform the plurality of operations (the turning operation and the operation of moving horizontally in the approaching and separating direction to and from the body cover 7), it is not necessary to separately provide the device for turning the turning member 34 and the device for moving the turning member 34 horizontally in the approaching and separating direction to and from the body cover 7, which eliminates the time (passing time) required to pass the pallets 21, 22 between these devices. Accordingly, when exchanging the first pallet 21 and the second pallet 22 between the table 6 and the pallet exchanger 8, the passing time is not accumulated, whereby the time required to exchange the first and second pallets 21, 22 can be reduced.

By opening the double doors 46, 47 on the front surface 9A of the side cover 9 to open the opening 45, the user of the vertical machining center 1 can carry the first pallet 21, on which the machined workpiece is mounted, out of the side cover 9 from the first holding arms 40, 40 through the opening 45, or can carry the second pallet 22, on which the workpiece to be machined is mounted, into the side cover 9 through the opening 45 so that the second pallet 22 is held by the second holding arms 41, 41 of the turning member 34. The front surface of the body cover 7 of the vertical machining center 1 can be located close to the opening 45 through which the workpiece is carried into and out of the side cover 9. This makes it easier for the user of the vertical machining center 1 to carry the workpiece into and out of the side cover 9 and operate the operation unit 28 on the front surface of the body cover 7, for example.

Moreover, the swing shaft 19 for the table 6 is not provided at a position in the horizontal movement direction of the turning member 34 toward the body cover 7 in the machining space 25. The swing shaft 19 therefore does not interfere with the approach of the turning member 34 to the table 6.

In addition, the vertical dimension of the support portion 17 is made smaller than that of the swing drive device 18. This can make it less likely for the workpiece on the table 6 to hide behind the support portion 17 and thus can make it less likely for the user of the vertical machining center 1 to have difficulty in checking or inspecting the workpiece on the table 6 through the opening 26 after opening it by horizontally moving the open and close door 27 of the body cover 7, for example. This makes it easier to check or inspect the workpiece on the table 6.

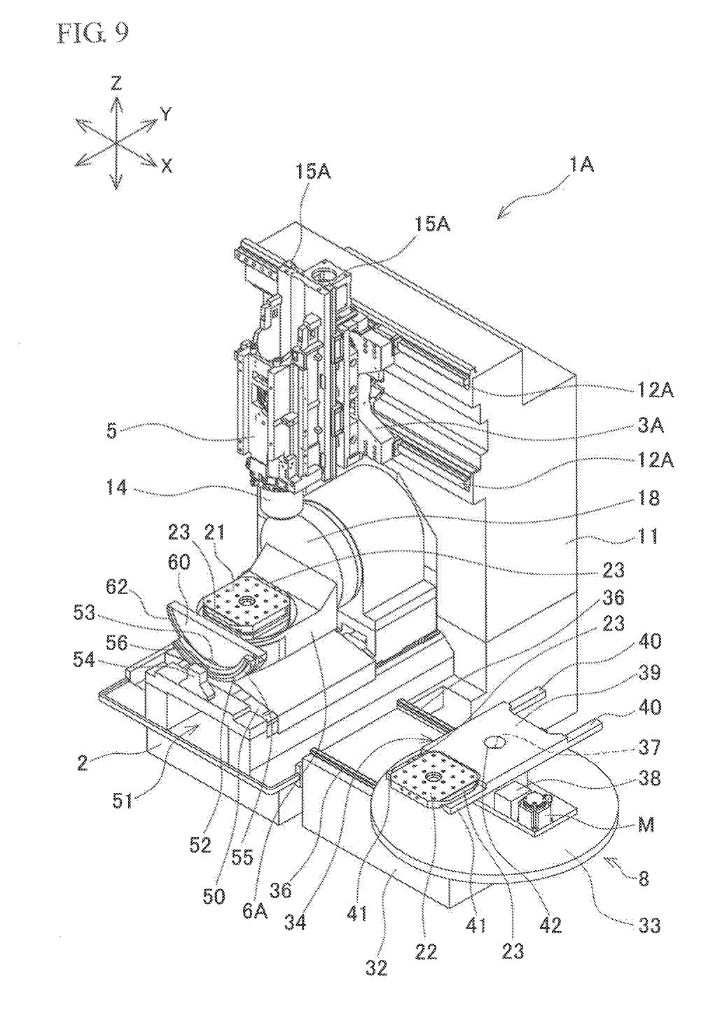

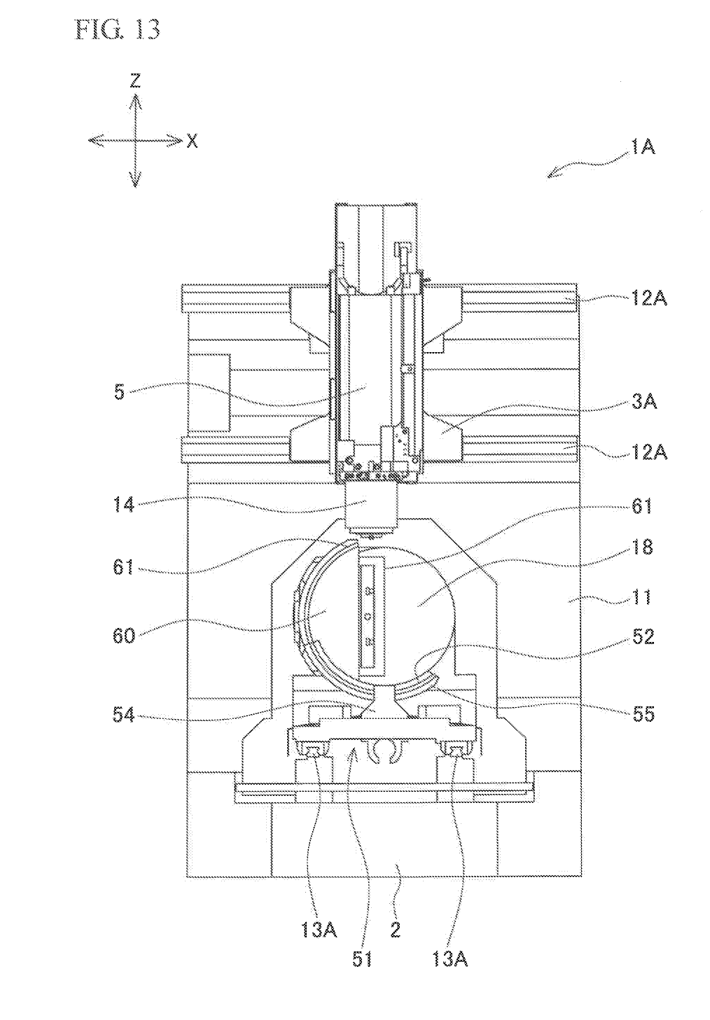

A second embodiment of the present invention will be described with reference to FIGS. 9 to 14. The same configurations as those of the first embodiment will be denoted by the same reference characters, and description thereof will be omitted. A vertical machining center IA according to the second embodiment also includes a body cover 7 and a side cover 9, both not shown. As shown in FIG. 9, a saddle 3A is provided over the front surface of a standing portion 11 such that the saddle 3A can be guided by X-axis guide rails 12A, 12A to move in an X-axis direction. A spindle head 5 is provided over the front surface of the saddle 3A such that the spindle head 5 can be guided by Z-axis guide rails 15A, 15A to move in a Z-axis direction parallel to the axis of a spindle 14.

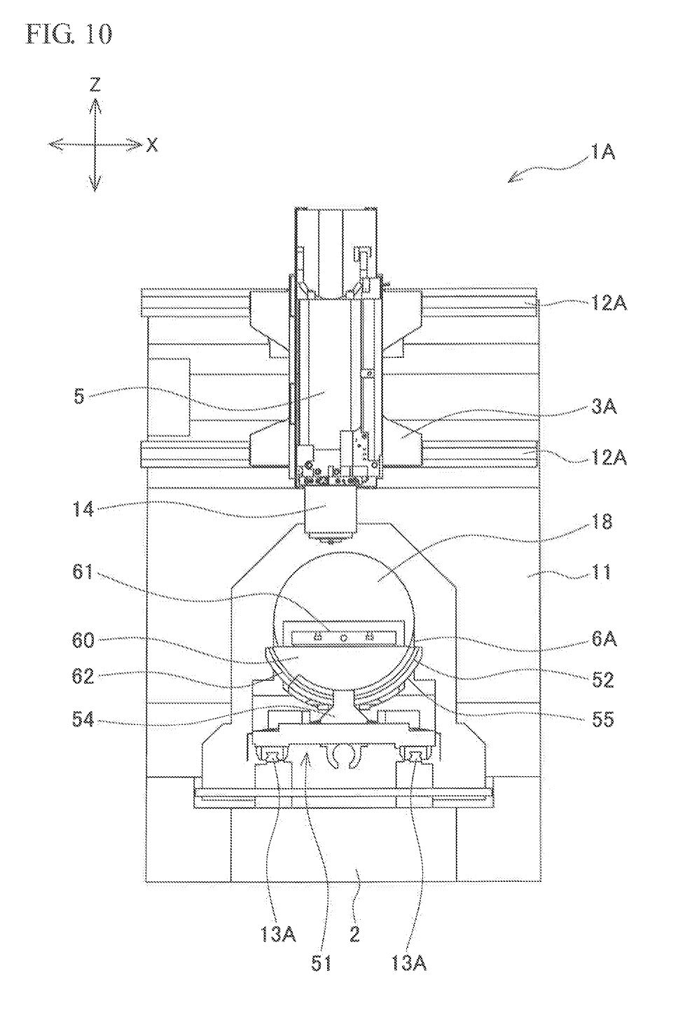

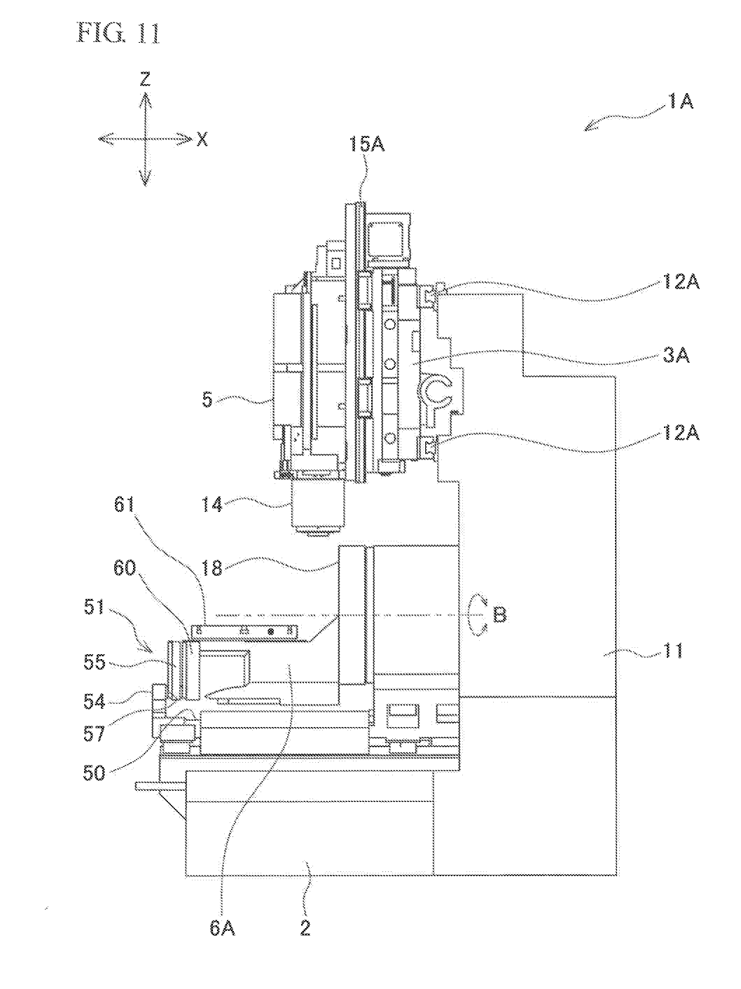

A slide table 50 shown in FIGS. 9 and 11 is provided over the upper surface of a bed 2 such that the slide table 50 can be guided by Y-axis guide rails 13A, 13A (see FIG. 10) to move in the longitudinal direction of the bed 2 (Y-axis direction). A swing drive device 18 is provided to stand at the rear end of the slide table 50, and a support portion 51 is provided to stand at the front end of the slide table 50. The support portion 51 swingably supports the front part of a table 6A.

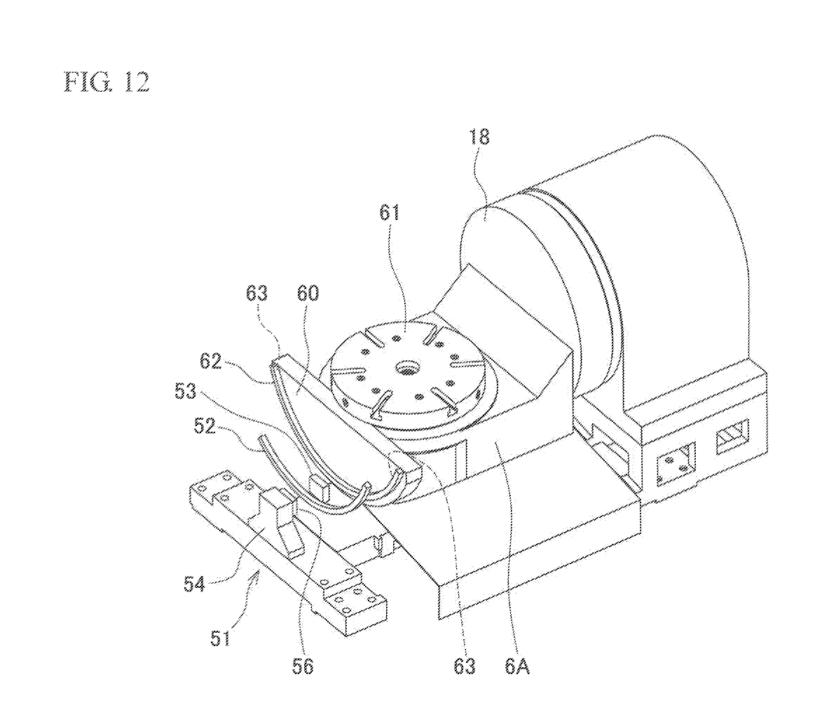

As shown in FIG. 12, a semicircular plate 60 has a flat upper surface and is fixed to the front surface of the table 6A. The upper surface of the semicircular plate 60 is located below a workpiece fixing mechanism 61 provided on the upper surface of the table 6A. A fixed rail 62 (see FIG. 12.) is attached to the front surface of the semicircular plate 60. The fixed rail 62 has a semicircular arc shape about a B-axis (see FIG. 11), and has a rail groove (not shown) formed in its upper surface so as to extend from one end to the other end of the upper surface. A standing wall 63 (see FIG. 12) is formed at both ends of the rail groove so as to close both ends of the rail groove. The fixed rail 62 is an example of the first rail member in the present invention.

As shown in FIGS. 9 and 12, the support portion 51 includes a movable rail 52, an engagement member 53, and a movable rail support member 54. The movable rail 52 has an arc shape about the B-axis (see FIG. 11), and is fixed to the front surface of a member having an arc shape as viewed in plan (arc-shaped member 55, see FIGS. 9 to 11). The engagement member 53 is fixed to the rear surface of the arc-shaped member 55. The engagement member 53 is fitted in and slidably engaged with the rail groove of the fixed rail 62. The movable rail support member 54 is provided to stand at the front end of the slide table 50. A guide member 56 is provided to protrude from the rear surface of the movable rail support member 54. The guide member 56 (see FIGS. 9 and 12) has a guide groove 57 (see FIG. 11) that is formed to have an arc shape about the B-axis and to open in its surface on the opposite side from the movable rail support member 54 and in its right and left side surfaces. The movable rail 52 is slidably fitted in the guide groove 57. As shown in FIGS. 9 and 10, before the table 6A swings about the B-axis, the movable rail 52 is fitted in the guide groove 57 and is located below the fixing mechanism 61 on the table 6A. As described below, the movable rail 52 can be guided by the guide groove 57 to swing about the B-axis. In the present embodiment, as shown in FIG. 11, the vertical dimension of the support portion 51 is made smaller than that of the swing drive device 18. The support portion 51 is an example of the support portion placed in front of the table in the present invention.

Operation of swinging the table 6A about the B-axis will be described below. The swing drive device 18 is swung and rotated in a forward direction from such a position that the table 6A is indexed so that the upper surface of the table 6A faces upward and extends horizontally, as shown in FIGS. 9 and 10. As shown in FIGS. 9 and 10 and FIGS. 13 and 14, the fixed rail 62 attached to the semicircular plate 60 on the front surface of the table 6A thus swings and rotates in the forward direction about the B-axis (see FIG. 11) while being engaged with the engagement member 53. The table 6A also swings and rotates in the forward direction about the B-axis accordingly. At this time, the fixed rail 62 does not protrude beyond the upper surface of the table 6A from the front surface of the table 6A. Accordingly, even if a pallet on which a workpiece is mounted has been fixed to the fixing mechanism 61, the workpiece does not hide behind the fixed rail 62. The user of the vertical machining center IA can therefore easily check or inspect the workpiece on the table 6A through an opening 26 (see FIG. 1) of the body cover 7. The B-axis is an example of the axis of the swing shaft in the present invention.

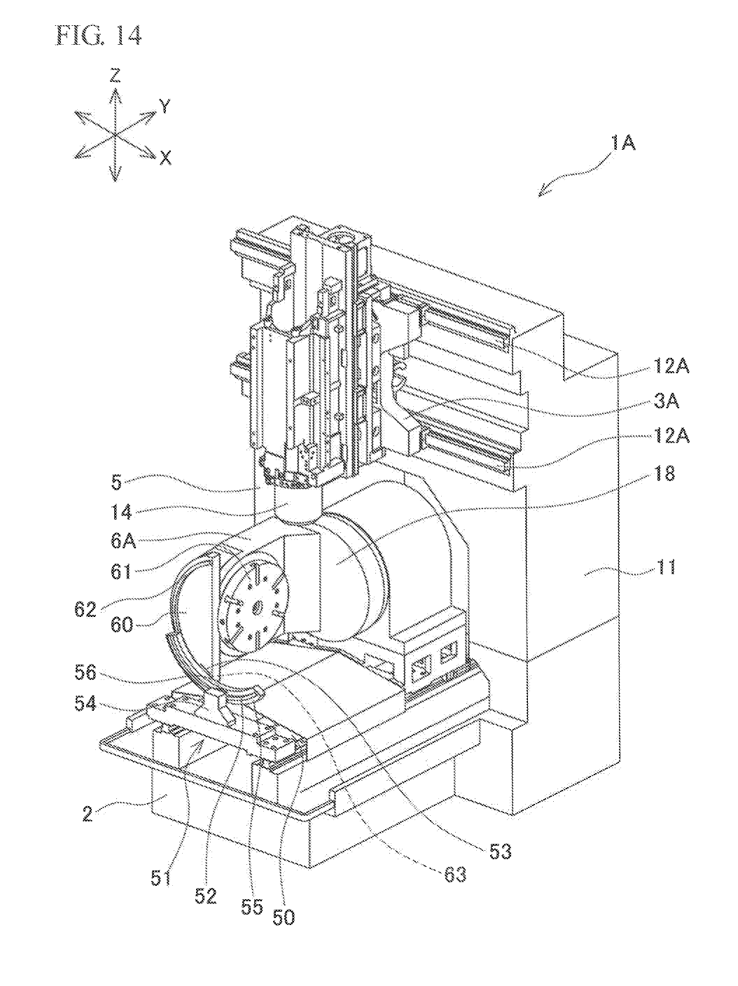

If the fixed rail 62 continues to swing and rotate in the forward direction, one of the standing walls 63 of the fixed rail 62 contacts the engagement member 53 as shown in FIG. 14. If the fixed rail 62 still continues to swing and rotate in the forward direction after the standing wall 63 contacts the engagement member 53, the engagement member 53 engages with the standing wall 63, and the standing wall 63 applies a force to the engagement member 53, the arc-shaped member 55, and the movable rail 52 so as to press them in the forward direction. The movable rail 52 subjected to this force is guided by the guide groove 57 (see FIG. 11) to swing and rotate in the forward direction together with the fixed rail 62. The table 6A thus swings in the forward direction by a swingable angle defined by the forward swinging range of the movable rail 52 in addition to a swingable angle defined by the forward swinging range of the fixed rail 62. The movable rail 52 is an example of the second rail member in the present invention, and the standing wall 63 is an example of the engagement portion in the present invention.

Even when the swing drive device 18 is swung and rotated in the reverse direction in the state shown in FIGS. 9 and 10, the other standing wall 63 (the standing wall 63 on the far left side in FIG. 12) of the fixed rail 62 applies a force to the movable rail 52 to press it in the reverse direction. The table 6A thus swings in the reverse direction by a swingable angle defined by the reverse swinging range of the movable rail 52 in addition to a swingable angle defined by the reverse swinging range of the fixed rail 62.

In the vertical machining center 1A of the present embodiment, before the table 6A starts swinging about the 9-axis or when the table 6A swings about the B-axis, the fixed rail 62 does not protrude beyond the upper surface of the table 6A from the front surface of the table 6A. A workpiece fixed to the table 6A therefore does not hide behind the fixed rail 62, and the user of the vertical machining center IA can easily check or inspect the workpiece.

The table 6A can be swung by the swingable angle defined by the forward and reverse swinging range of the movable rail 52 in addition to the swingable angle defined by the forward and reverse swinging range of the fixed rail 62. The swingable angle of the table 6A can thus be increased as compared to the case where the table 6A is swung according to swinging of the fixed rail 62.

The present invention is not limited to the above embodiments, and a part of the configuration can be modified as appropriate without departing from the spirit and scope of the invention. Unlike the first embodiment, the swing drive device 18 may not be provided, and the rear part of the table 6 may be supported by the standing portion 11 via a s wing shaft, and the standing portion 11 may be provided with a B-axis motor that rotates and feeds the swing shaft. This standing portion 11 is an example of the support portion in the present invention.

Unlike the first and second embodiments, the table 6, 6A instead of the moving base 33 may be able to advance and withdraw toward and from the pallet exchanger 8 through the workpiece loading and unloading port 29. In this case, the first pallet 21 on which a machined workpiece is mounted and the second pallet 22 on which a workpiece to be machined is mounted may be carried between the table 6, 6A and the pallet exchanger 8 by advancing the table 6, 6A toward the pallet exchanger 8 through the workpiece loading and unloading port 29 and then turning the turning member 34 in the side cover 9 (on the pallet exchanger 8 side). Thus, the turning member 34 need not be moved in the approaching and separating direction to and from the body cover 7. Namely, the turning member 34 need only be turned in the side cover 9 in order to carry the first pallet 21 on which the machined workpiece is mounted and the second pallet 22 on which the workpiece to be machined is mounted between the table 6, 6A and the pallet exchanger 8. Moreover, unlike the first and second embodiments, the turning member 34 may be able to advance and withdraw into and from the machining space 25 through the workpiece loading and unloading port 29 as well as the table 6, 6A may be able to advance and withdraw toward and from the pallet exchanger 8 through the workpiece loading and unloading port 29.

Unlike the first and second embodiments, the lifting device 38 may not be provided on the upper surface of the moving base 31 in this case, the turning member 34 may be provided on a plane above the upper surface of the table 6, 6A so as to be rotatable horizontally, and a lifting device capable of lifting and lowering a pallet placed on the upper surface of the table 6, 6A with respect to the first holding arms 40, 40 or the second holding arms 41, 41 of the turning member 34 located above the upper surface of the table 6, 6A may be provided on the upper surface of the table 6, 6A, Unlike the second embodiment, a retaining piece that protrudes upward may be provided on each of the upper surfaces of both ends of the movable rail 52, so that the guide member 56 engages with the retaining piece when the movable rail 52. reaches the limit of its swinging range. This can prevent the movable rail 52 from coming off from the guide groove 57 of the guide member 56. Unlike the first and second embodiments, the pallet exchanger 8 may be placed adjacent to the right side surface 7A of the body cover 7 without being covered by the side cover 9, and the first holding arms 40, 40 or the second holding arms 41, 41 may be indexed to such a position that the first holding arms 40, 40 or the second holding arms 41, 41 faces toward the front of the pallet exchanger 8 by turning the turning member 34 in the horizontal direction on the pallet exchanger 8 side. In this case, the user of the vertical machining center 1 can carry the first pallet 21, on which a machined workpiece is mounted and that is held on the first holding arms 40, 40, out of the pallet exchanger 8 from the front of the pallet exchanger 8, or can carry the second pallet 22, on which a workpiece to be machined is mounted, toward the second holding arms 41, 41 from the front of the pallet exchanger 8. This makes it easier for the user of the vertical machining center 1 to carry a workpiece into and out of the pallet exchanger 8. Unlike the first and second embodiments, there may be clearance between the side cover that covers the pallet exchanger 8 and the right side surface 7A of the body cover 7.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A machine tool that is capable of machining a workpiece with a tool by relatively moving the tool and a table in a workpiece machining space provided in a body of the machine tool, the machine tool comprising:
pallets on which the workpiece is mounted;
a body cover that covers the machining space and that is provided with a first door, the first door facing the machining space and opening and closing an opening provided on a front surface of the body cover;
a pallet exchanger that is placed adjacent to one side of the body cover and that exchanges the pallets including a first pallet and a second pallet, the first pallet being fixed to an upper surface of the table and a machined workpiece being mounted on the first pallet, and a workpiece to be machined being mounted the second pallet, wherein
the pallet exchanger includes a turning member that has a first holding portion and a second holding portion formed in a pair and turns in a horizontal direction, the first holding portion is located at a first end of the turning member and holds the first pallet, and the second holding portion is located at a second end that is on the opposite side of the turning member from the first end and holds the second pallet,
at least one of the turning member and the table can be advanced and withdrawn through a workpiece loading and unloading port provided in the body cover,
the turning member is advanced and withdrawn into and from the machining space through the workpiece loading and unloading port, and the first pallet held by the first holding portion is carried from the upper surface of the table to the pallet exchanger and the second pallet held by the second holding portion is carried from the pallet exchanger to the upper surface of the table in the machining space, by advancing the turning member into the machining space through the workpiece loading and unloading port and then turning the turning member in the horizontal direction in the machining space, and
the table is advanced and withdrawn toward or from the pallet exchanger through the workpiece loading and unloading port, and the first pallet held by the first holding portion is carried from the upper surface of the table to the pallet exchanger and the second pallet held by the second holding portion is carried from the pallet exchanger to the upper surface of the table, by advancing the table toward the pallet exchanger through the workpiece loading and unloading port and then turning the turning member in the horizontal direction on the pallet exchanger side.

2. The machine tool according to claim 1, wherein
the first holding portion or the second holding portion can be indexed to such a position that the first holding portion or the second holding portion faces toward a front of the pallet exchanger by turning the turning member in the horizontal direction on the pallet exchanger side.

3. The machine tool according to claim 1, wherein
a side cover that covers the pallet exchanger is provided on one side of the body cover, and the side cover is provided with a second door that faces the turning member and that opens and closes an opening provided on a front surface of the side cover.

4. The machine tool according to claim 1, wherein
the table can swing about a swing shaft that extends perpendicularly to an approaching and separating direction of the turning member to and from the body cover.

5. The machine tool according to claim 4, wherein
support portions that swingably support the swing shaft are placed in front of and behind the table, respectively, and the support portion placed in front of the table is made smaller than that placed behind the table.

6. The machine tool according to claim 5, wherein
a first rail member having an arc shape about an axis of the swing shaft is fixed to a front surface of the table at a position below the upper surface of the table, and the support portion placed in front of the table is provided with an engagement member that engages with the first rail member, and
the table swings about the swing shaft as the swing shaft swings and the first rail member swings about the swing shaft while being engaged with the engagement member.

7. The machine tool according to claim 6, wherein
a second rail member located at a position below the upper surface of the table before swinging, having the engagement member fixed thereto, and having an arc shape about the axis of the swing shaft is supported by the support portion placed in front of the table so that the second rail member can swing about the swing shaft, and
the first rail member is provided with an engagement portion that is engaged by the engagement member, and that swings the second rail member about the swing shaft as the first rail member swings about the swing shaft.
